(19) United States
(12) Patent Application Publication
(10) Pub. No.: US 2013/0202883 A1
(43) Pub. Date: Aug. 8, 2013

(54) LAMINATED STRUCTURE FOR DISPLAYING INFORMATION

(71) Applicants: Alexandra Dekoninck, Eaubonne (FR); Jean Sablayrolles, Crouy En Thelle (FR)

(72) Inventors: Alexandra Dekoninck, Eaubonne (FR); Jean Sablayrolles, Crouy En Thelle (FR)

(73) Assignee: Saint-Gobain Glass France, Courbevoie (FR)

(21) Appl. No.: 13/808,682

(22) PCT Filed: Jul. 6, 2011
(86) PCT No.: PCT/FR2011/051612

§ 371 Date: Apr. 16, 2013

(30) Foreign Application Priority Data
Jul. 7, 2010 (FR) 10/02860

(51) Int. Cl. G02B 1/10

(52) U.S. Cl. CPC G02B 1/10
USPC 428/341; 427/66; 428/354; 428/426; 428/412; 428/523; 428/474.4

(57) ABSTRACT

The invention relates to:

a laminated structure comprising at least successively a substrate, a phosphor first layer and an adhesive polymer material second layer;

a process for preparing this structure;

a laminated glazing comprising this structure.

The present invention relates to a display device, particularly to a transparent display device, which operates with phosphors. It is especially a laminated glazing for viewing information that is of the transport vehicle windshield, architectural glazing or street furniture glazing type. Thus, already known are, for example, motor vehicle windshields equipped with head-up display (HUD) systems.

Layers may be formed for this purpose by depositing, via screen printing, a paste consisting of polyvinyl butyral, a solvent such as cyclohexanone and a phosphor. This deposition technique is described in document FR-A-2 929 017.

The inventors have now sought a means of printing phosphors onto the laminated glazing interlayer adhesive (polyvinyl butyral or equivalent) or onto glass, without the phosphor layer being damaged during handling or storage operations prior to the assembly of the laminated glazing.

For this purpose, one subject of the invention is a laminated structure comprising at least successively a substrate, a phosphor first layer and an adhesive polymer material second layer. The inventors realized that this structure guaranteed the desired protection and durability of the phosphor layer, and developed techniques and precursors for the deposition of these two layers. The manufacture of laminated glazings for viewing information is thus both possible and made easier.

Within the meaning of the invention, an adhesive polymer material denotes that of the interlayer which bonds two more or less rigid, transparent sheets made of a glassy material or polymer, in a laminated glazing. Examples thereof will be given below.

The inventors have been able to create conditions of perfect compatibility and adhesion of the first layer to the substrate, of the second layer to the first layer, and overall of the laminated structure itself within the laminated glazing having an information viewing device.

According to preferred features of the laminated structure of the invention:
it is transparent;
the substrate is selected from:
a mineral material, especially a glassy material (glass, glass-ceramic, etc.), and
a polymer material selected in particular from polycarbonate, acrylic polymer such as polymethyl (meth)acrylate, polyolefin, polyamide, ionomer resin and the like, alone or as a mixture of several thereof, or else a polymer material that is adhesive and compatible with that of the second layer;
the phosphor is selected from a coumarin, a stilbene, a betaine, a complex of rare earth elements, a derivative of rhodamine, of fluorol, of terephthalate, naphthal, naphthalimide, oxazole, perylene, phenyl, pyrene, styryl or xanthene, alone or as a mixture of several thereof;
the phosphor first layer comprises an adhesive polymer material compatible with that of the second layer;
the adhesive polymer material of the second layer is selected from a polyvinyl butyral, a polyurethane, an ethylene/vinyl acetate copolymer, alone or as a mixture of several thereof; in particular any quality of polyvinyl butyral, being textured, being rough or not, providing sound insulation or not, and being more or less plasticized, may be used;
the surface density of phosphor of the first layer is at least equal to 0.1, preferably 1 g/m², at most equal to 5, preferably 3.5 g/m²;
the surface density of adhesive polymer material of the second layer is at least equal to 1, preferably 7 g/m², at most equal to 20, preferably 14 g/m²;
it comprises a sheet made of glassy material bonded directly to the adhesive polymer material second layer, or connected thereto by means of an adhesive polymer material third layer;
it comprises a sheet made of glassy material bonded directly to the substrate, or connected thereto by means of an adhesive polymer material fourth layer.

Another subject of the invention consists of a process for preparing a laminated structure as described above, comprising the operations
of depositing on the substrate a phosphor solution, then
of depositing, on the phosphor first layer that results therefrom, an adhesive polymer material solution.

According to preferred features of this process:
the phosphor and adhesive polymer material solutions have, as solvent, an alcohol such as methanol, ethanol, n- and iso-propanol, n- and sec-butanol or benzyl alcohol, a cellosolve such as methyl cellosolve, ethyl cellosolve or butyl cellosolve, a ketone such as acetone, methyl ethyl ketone, cyclohexanone or isophorone, an amide such as dimethylacetamide, N,N-dimethylformamide or N-methyl-2-pyrrolidone, an ether such as dioxane or tetrahydrofuran, or an aromatic hydrocarbon such as toluene or pyridine, alone or as a mixture of several thereof;
the phosphor solution comprises an adhesive polymer material compatible with that of the adhesive polymer material solution;
the deposition of each solution is carried out by spraying, screen printing, inkjet printing or the like.

Another subject of the invention consists of a laminated glazing for viewing information that is of the transport vehicle windshield, architectural glazing or street furniture glazing type, comprising a laminated structure as described previously.

The invention is now illustrated by the following examples, in which the proportions indicated are weight percentages.

### EXAMPLE 1

Formulation of the Phosphor Solution:

Dissolution of diethyl 2,5-dihydroxyterephthalate and of PVB sold by the company Solutia under the commercial reference RF41 in THF (tetrahydrofuran) with the following ratios: phosphor/PVB/solvent=2/2/96.

Formulation of the PVB Solution:

Dissolution of PVB RF41 in THF with the following ratio: PVB/solvent=2/98.

These mixtures are stirred until the phosphor and PVB are perfectly solubilized.

The solutions of phosphor then of PVB are successively deposited by spraying onto a 300×300 mm² PVB RF41 substrate. The nozzle passes over the substrate eight times (four back-and-forth passes), which operation is repeated four times, turning the substrate each time by a quarter of a turn.

The following spraying parameters are used:
spraying pressure: 3.5 bar
flow rate: 70 ml/min
sweep rate: 300 mm/s.

A phosphor first layer having a surface density of 3 g/m² and a polyvinyl butyral second layer having a surface density of 7 g/m² are obtained. The PVB solution is not sprayed until the phosphor first layer is dry.

Moreover, the roughness of the substrate was characterized before and after the two successive depositions.

The mean roughness Ra is the arithmetic mean of the deviations of the filtered roughness profile, from the mean line during the course of the measurement, according to the standards DIN 4768/1; DIN 4762/1E and ISO/DIN 4287.

The mean roughness depth RZ is the arithmetic mean of the roughness depths taken from five successive measurement fractions of the filtered roughness profile according to the standard DIN 4768/1.

Over several samples, the values of Ra (μm) and respectively RZ (μm) are from 9 to 11, respectively 41 to 48 μm before, and 7 to 8, respectively 34 to 36 μm after the two successive depositions.

### EXAMPLE 2

Example 1 is reproduced with the following formulations, using two solvents.

Formulation of the Phosphor Solution:

Dissolution of diethyl 2,5-dihydroxyterephthalate and of PVB RF41 in THF (solvent 1) and ethanol (solvent 2) with the following ratios: phosphor/PVB/solvent 1/solvent 2=2/2/48/48.

Formulation of the PVB Solution:

Dissolution of PVB RF41 in THF (solvent 1) and ethanol (solvent 2) with the following ratio: PVB/solvent=2/49/49.

The roughness measurements of the substrate before and after the two successive depositions give values in the same ranges as example 1.

### EXAMPLE 3

Example 1 is reproduced with the following formulations, using PVB sold by the company Solutia under the commercial reference AG21.

Formulation of the Phosphor Solution: Dissolution of diethyl 2,5-dihydroxyterephthalate and of PVB AG21 in THF (tetrahydrofuran) with the following ratios: phosphor/PVB/solvent=2/2/96.

Formulation of the PVB Solution:

Dissolution of PVB AG21 in THF with the following ratio: PVB/solvent=2/98.

### EXAMPLE 4

Example 1 is reproduced in the absence of PVB in the phosphor solution.

Formulation of the Phosphor Solution:

Dissolution of diethyl 2,5-dihydroxyterephthalate in THF (tetrahydrofuran) with the following ratios: phosphor/solvent=2/98.

Formulation of the PVB Solution:

Dissolution of PVB RF41 in THF with the following ratio: PVB/solvent=2/98.

### EXAMPLE 5

Example 1 is reproduced with a solution of another phosphor, which does not also contain PVB.

Formulation of the phosphor solution:

Dissolution of a europium complex (Eu(NTA)₃·2H₂O; NTA=1-(2-naphthoyl)-3,3,3-trifluoroacetonate)) in THF (tetrahydrofuran) with the following ratios: phosphor/solvent=2/98.

Formulation of the PVB Solution:

Dissolution of PVB RF41 in THF with the following ratio: PVB/solvent=2/98.

In each of these examples layers are obtained that have perfect luminescent functionality and are protected by their PVB coating, so that they can be subjected to any common handling operations without being adversely affected thereby in any way.

In addition, when, in order to prepare the laminated structure of the invention, use was made at the start of a PVB of substantial roughness (30 μm<RZ<50 μm or 7 μm<Ra<12 μm), said first and second layers reduced the initial roughness of the substrate by 30% or even 20% at the very most and up to 10% to 0% in certain cases. In other words, the initial roughness of the substrate was virtually maintained, which may constitute an advantage when this roughness aims to facilitate the degassing for example, during the assembly of a laminate.

1. A laminated structure, comprising, at least Successively;
a substrate;
a first layer comprising a phosphor; and
a second layer comprising an adhesive polymer material.

2. The laminated structure of claim 1, wherein the laminated structure is transparent.

3. The laminated structure of claim 1, wherein the substrate is a mineral material or a polymer material.

4. The laminated structure of claim 3, wherein the substrate is a mineral material and the mineral material is a glassy material.

5. The laminated structure in of claim 3, wherein the substrate is a polymer material and the polymer material is a polycarbonate, an acrylic polymer, a polyolefin, a polyamide, an ionomer resin, any mixture thereof.

6. The laminated structure of claim 3, wherein the substrate is a polymer material, and the polymer material is an adhesive that is compatible with the adhesive polymer material of the second layer.

7. The laminated structure of claim 1, wherein the phosphor is a coumarin, a stilbene, a betaine, a complex of a rare earth element, a derivative of rhodamine, a derivative of fluorol, a derivative of terephthalate, naphthal, naphthalimide, oxazole, perylene, phenyl, pyrene, styryl, xanthene, or any mixture thereof.

8. The laminated structure of claim 1, wherein the first layer comprises an adhesive polymer material compatible with the adhesive polymer material of the second layer.

9. The laminated structure of claim 1, wherein the adhesive polymer material of the second layer is a polyvinyl butyral, a polyurethane, an ethylene/vinyl acetate copolymer, or any mixture thereof.

10. The laminated structure of claim 1, wherein the surface density of phosphor of the first layer is at least equal to 0.1 g/m².

11. The laminated structure of claim 1, wherein the surface density of phosphor of the first layer is at most equal to 5 g/m².

12. The laminated structure of claim 1, wherein the surface density of adhesive polymer material of the second layer is at least equal to 1 g/m².

13. The laminated structure of claim 1, wherein the surface density of adhesive polymer material of the second layer is at most equal to 20 g/m².

14. The laminated structure of claim 1, further comprising:
a sheet comprising a glassy material bonded directly to the second layer, or connected thereto with a third layer comprising an adhesive polymer material.

15. The laminated structure of claim 1, further comprising:
a sheet comprising a glassy material bonded directly to the substrate, or connected thereto with a fourth layer comprising an adhesive polymer material.

16. A process for preparing the laminated structure of claim 1, the process comprising:
depositing phosphor solution on the substrate, to obtain the first layer comprising the phosphor; and then
depositing an adhesive polymer material solution on the first layer.

17. The process of claim 16, wherein the phosphor and adhesive polymer material solutions each independently comprise, as a solvent, an alcohol, a cellosolve, a ketone, an amide, an ether, an aromatic hydrocarbon, or any mixture thereof.

18. The process of claim 16, wherein the phosphor solution comprises an adhesive polymer material, which is compatible with the adhesive polymer material solution.

19. The process of claim 16, wherein the deposition of each solution is carried out by spraying, screen printing, or inkjet printing.

20. A laminated glazing, comprising the laminated structure of claim 1.
